(19) United States
(12) Patent Application Publication
(10) Pub. No.: US 2016/0123297 A1
(43) Pub. Date: May 5, 2016

(54) IMPROVEMENTS TO THE SYSTEM FOR GENERATING ENERGY FROM THE MOVEMENT OF THE WAVES OF THE SEA

(71) Applicant: Francisco AZPIROZ VILLAR, Sebastian (Gipuzkoa) (ES)

(72) Inventor: Francisco AZPIROZ VILLAR, San Sebastian (Gipuzkoa) (ES)

(21) Appl. No.: 14/895,122

(22) PCT Filed: Jun. 5, 2013
(86) PCT No.: PCT/ES2013/070358

§ 371 Date: Dec. 1, 2015

(51) Int. Cl. F03B 13/16

(52) U.S. Cl. CPC F03B 13/16

(57) ABSTRACT

The invention relates to improvements to the system for generating energy from the movement of the waves of the sea, according to which, given two consecutive buoys (1ᵢ), (1ᵢ₊₁) having respective diameters (dᵢ), (dᵢ₊₁) arranged relative to the vessel (2) at a distance (Zᵢ), (Zᵢ₊₁) respectively, the distances (Zᵢ), (Zᵢ₊₁) . . . (Zₙ₋₁), (Zₙ) of the buoys (1ᵢ) and (1ᵢ₊₁), . . . (1ₙ₋₁), (1n) relative to the vessel (2), always have a value of Z=k·d, wherein (d) is the diameter of the smallest buoy provided in the distribution, and (k) is a value of no less than one. When the value (D_{z}) corresponding to the difference between the distances (Zᵢ), (Zᵢ₊₁) of said buoys (1ᵢ) and (1ᵢ₊₁) relative to the vessel (2) is less than the diameter (dᵢ) of the preceding buoy (1ᵢ), the longitudinal separation (Lᵢ) in the direction (A) between the centre points of two consecutive buoys (1ᵢ) and (1ᵢ₊₁) is no less than twice the diameter (dᵢ) of the preceding buoy (1ᵢ); and when said value (D_{z}) is no less than the diameter (dᵢ) of the preceding buoy (1ᵢ), the horizontal separation (Lᵢ) must be no less than half the diameter (dᵢ) of the preceding buoy (1ᵢ)

The object of the main patent refers to a system for generating energy from the movement of the waves of the sea, seeking economy in its construction, transport, installation and maintenance, for which at least one floating element (buoy) is necessary, which moves with respect to a point, and which makes it possible to mark the reference of the movement.

In the system for generating energy from the movement of the waves of the sea, according to the main patent, the positioning of the buoys on each side of the vessel has been shown to be of fundamental importance in achieving the objective of obtaining optimal effectiveness in generating energy.

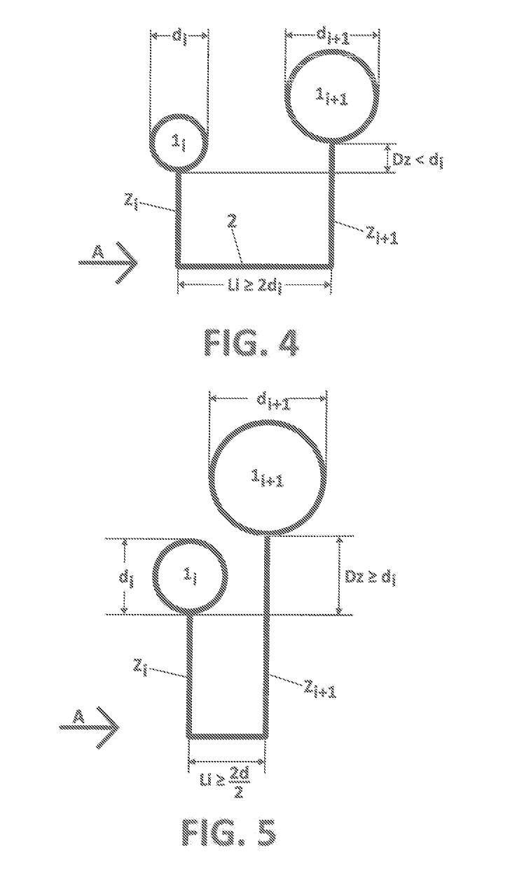

The applicant has verified that the distribution of the buoys on each side of the vessel, for example, as shown in FIGS. 4 and 5 of the main patent, obtains low performance (low effectiveness) in generating energy.

The applicant has verified that the main cause of said low performance (low effectiveness) is due to the “shadow effect” produced by a buoy on the following ones, aligned with it in the forward direction of the wave.

The improvements in the object of the main patent, according to the invention, consist of distributing the greatest number of buoys in the smallest possible space, but always avoiding the aforementioned “shadow effect” that a buoy exerts on those that immediately follow it.

For the purposes of the invention, the “shadow effect” refers to the minimum separation there must be between two consecutive buoys aligned in the forward direction of the wave so that the distortion of the wave caused by the movement of the first buoy (or, in general, of the movement of a buoy) does not affect the movement of the second one (or, in general, the movement of the following buoys).

Therefore, the content of this application constitutes a new invention that involves inventive activity, and can be used for industrial application.

To better understand the object of this invention, a preferential form of practical embodiment is shown in the drawings, subject to accessory changes which do not essentially alter it.

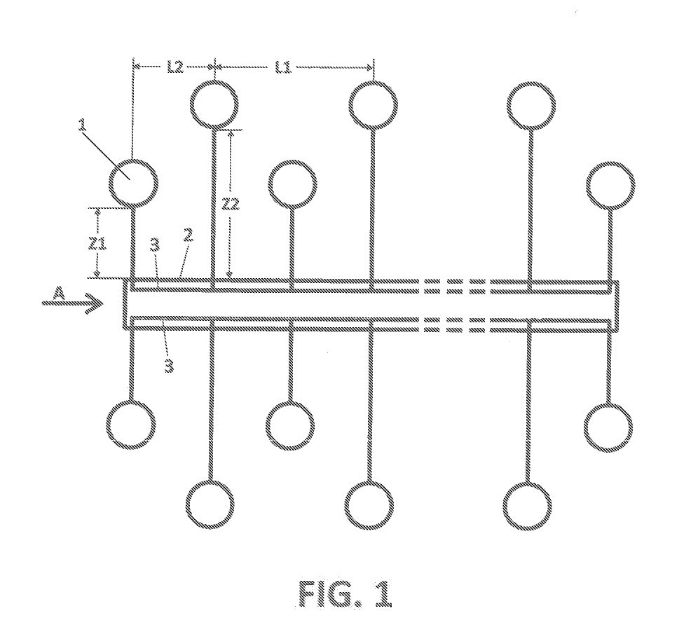

FIG. 1 is a general scheme of “n” buoys (1ᵢ), (1ₙ₊₁), . . . (1ₙ₋₁), (1ₙ) arranged in pairs on both sides of the structure (B), according to this addition.

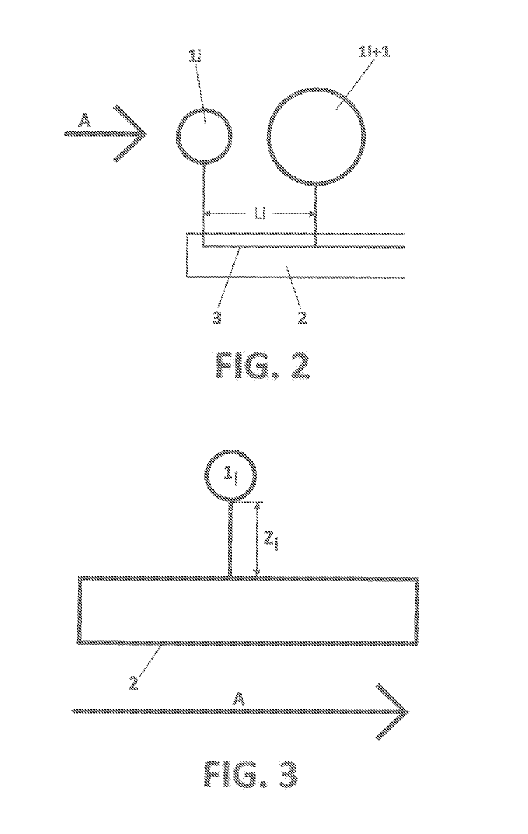

FIG. 2 is a partial scheme representing the minimum separation (Li) necessary between two consecutive buoys (1ᵢ), (1ᵢ₊₁) to prevent the “shadow effect”.

FIG. 3 is a partial scheme representing a first buoy (1ᵢ) of diameter (dᵢ) on one side of the vessel (2).

FIG. 4 is a partial scheme of a pair of buoys (1ᵢ), (1ᵢ₊₁) for the case in which the difference (D_{z}) between the distance of the buoys (1ᵢ), (1ᵢ₊₁) with respect to the vessel (2) is less than the diameter of the preceding buoy (1ᵢ).

FIG. 5 is a partial scheme of a pair of buoys (1ᵢ), (1ᵢ₊₁) for the case in which the difference (D_{z}) between the distances of the buoys (1ᵢ), (1ᵢ₊₁) with respect to the vessel (2) is greater than or equal to the diameter of the preceding buoy (1ᵢ).

These provisions, in any of the cases represented in FIGS. 4 and 5, are valid, in general, for the rest of the buoys (1ᵢ₊₂), (1ᵢ₊₂), . . . (1ₙ₋₁), (1ₙ) advancing longitudinally in the direction (A) of the main/most common wave, according to the general scheme of FIG. 1.

The following is a description of an example of practical, non-limiting embodiment of this invention. Other modes of embodiment in which accessory changes are introduced that do not essentially change it are by no means ruled out; on the contrary, this invention also encompasses all its variants.

According to the present addition, the improvements to the system for generating energy from the movement of the waves of the sea which are the object of the invention refer to the positioning of the buoys (1) on each side of the vessel (2) of the main patent, with the objective of obtaining optimal effectiveness in generating energy.

To achieve this, according to the present addition, it is necessary to distribute the greatest number of buoys (1) in the smallest possible space, but always avoiding the so-called “shadow effect” that any buoy (1) exerts on the one following it, aligned in the forward direction (A) of the main/most common wave.

This “shadow” effect refers to the minimum separation (Lᵢ) there must be between two consecutive buoys (1ᵢ) y (1ᵢ₊₁) aligned in the forward direction (A) of the main/most common wave, in order for the distortion in the wave produced by the movement of the first buoy (1ᵢ) to not affect the movement of the second buoy (1ᵢ₊₁). See FIG. 2.

To begin with the distribution of buoys, an initial buoy (1ᵢ) of diameter (dᵢ) is arranged on one side of the vessel (2) (See FIG. 3). This buoy (1ᵢ) is arranged in any position in the longitudinal direction (A) of the vessel (2), but at a distance (Zᵢ) with respect to the vessel (2). The value of this distance is:

Zᵢ=k·d where:
(d) is the diameter of the smallest buoy that will be arranged in the distribution, and
(k) is a value greater than or equal to one

Starting from this first buoy (1ᵢ), the rest are arranged, advancing or returning longitudinally along the direction (A) of the vessel (2), so that the following criteria are always fulfilled:
a)—The distances (Zᵢ), (Zᵢ₊₁) . . . (Zₙ₋₁), (Zₙ) of the buoys (1ᵢ) and (1ᵢ₊₁), . . . (1ₙ₋₁), (1ₙ) with respect to the vessel (2) always have a value Z=k·d, where (d) is the diameter of the smallest buoy that is to be arranged in the distribution, and (k) is a value greater than or equal to one.
b)—When the value (D_{z}) corresponding to the difference between the distances (Zᵢ) and (Zᵢ₊₁) of the two buoys (1ᵢ) and (1ᵢ₊₁) consecutive with respect to the vessel (2) is less than the diameter (dᵢ) of the preceding buoy (1ᵢ) in the longitudinal direction (A) of the vessel (2), the longitudinal separation (Lᵢ) in this direction (A) between the central points of the two consecutive buoys must be equal to or greater than double the diameter (dᵢ) of the preceding buoy (1ᵢ) to prevent the “shadow” effect, as shown in FIG. 4.
d)—When the value (D_{z}) corresponding to the difference between the distances (Zᵢ), (Zᵢ₊₁) of two consecutive buoys (1ᵢ) and (1ᵢ₊₁) with respect to the vessel (2) is greater than or equal to the diameter (dᵢ) of the preceding buoy (1ᵢ) in the longitudinal direction (A) of the vessel (2), the longitudinal separation (Lᵢ) in that direction (A) between the central points of the two consecutive buoys (1ᵢ) and (1ᵢ₊₁), must be equal to or greater than half of the diameter (dᵢ) of the preceding buoy (1ᵢ), as shown in FIG. 5.

This process is repeated for those buoys located on the other side of the vessel (2), completing an arrangement that may or may not vary, both in number of buoys and in their arrangement, but always following the criteria stated above.

It makes no difference for the purposes of the invention that the buoys are of equal diameters—as in FIG. 1—or of different diameters—as in FIGS. 4 and 5—.

The materials, dimensions, proportions and, in general, those other accessory or secondary details that do not essentially alter, change or modify the proposal can be variable.

The terms in which this report is drafted are a true reflection of the object described, and must be taken in their broadest sense, and never in a limiting manner.

1. Improvements to a system for generating energy from the movement of the waves of the sea, the generating system including buoys arranged on each side and successively in the longitudinal direction (A) of a vessel that is considered horizontal and given a preceding buoy (1ᵢ) and a successive subsequent buoy (1ᵢ₊₁) of respective diameters (dᵢ), (dᵢ₊₁) and arranged with respect to the vessel at a distance (Zᵢ), (Zᵢ₊₁) respectively, the following is fulfilled:
a) The distances (Zᵢ), (Zᵢ₊₁) . . . (Zₙ₋₁), (Zₙ) of the buoys (1ᵢ) y (1ᵢ₊₁), . . . (1ₙ₋₁), (1ₙ) with respect to the vessel, always have a value Z=k·d, where (d) is the diameter of the smallest buoy that is to be arranged in the distribution, and (k) is a value greater than or equal to one;
b) When the value (D_{z}) corresponding to the difference between the distances (Zᵢ), (Zᵢ₊₁) of two consecutive buoys (1ᵢ) and (1ᵢ₊₁) with respect to the vessel is less than the diameter (dᵢ) of the preceding buoy (1ᵢ) in the longitudinal direction (A) of the vessel, the longitudinal separation (Lᵢ) in that direction (A) between the central points of two consecutive buoys (1ᵢ) and (1ᵢ₊₁), must be equal to or superior to double the diameter (dᵢ) of the preceding buoy (1ᵢ):
D_{z}=|Zi−Zi+1|<dᵢ
Lᵢ≧2dᵢ
c) when the value (D_{z}) corresponding to the difference between the distances (Zᵢ), (Zᵢ₊₁) of two consecutive buoys (1ᵢ) and (1ᵢ₊₁) with respect to the vessel is greater than or equal to the diameter (dᵢ) of the preceding buoy (1ᵢ), the horizontal separation (Lᵢ) must be equal to or greater than half of the diameter (dᵢ) of the preceding buoy (1ᵢ)
D_{z}=|Zi−Zi+1|≧dᵢ
Lᵢ≧dᵢ/2.
